(19) United States
(12) Patent Application Publication
(10) Pub. No.: US 2014/0271009 A1
(43) Pub. Date: Sep. 18, 2014

(54) Crimp Ring Removal Tool

(71) Applicant: Bruns Daniel Kidd, Limington, ME (US)

(72) Inventor: Bruns Daniel Kidd, Limington, ME (US)

(21) Appl. No.: 14/212,593

(22) Filed: Mar. 14, 2014

Related U.S. Application Data
(60) Provisional application No. 61/790,119, filed on Mar. 15, 2013.

(51) Int. Cl. B23B 47/28

(52) U.S. Cl. CPC B23B 47/281
USPC 408/241 G

(57) ABSTRACT

A crimp ring removal tool for removing crimp rings from flexible tubing such as PEX. The tool is made from material of suitable hardness and comprises a collar block having at least one bore and ring slot pair to accommodate the dimensions of a flexible plumbing connection and a guide path to direct the operative portion of a common auxiliary cutting tool. The collar block is first secured in place against a plumbing connection with a clamping device such as locking pliers before the cutting tool is directed to interact with the crimp ring to be removed. Damage to the underlying plumbing fitting is spared or minimized because cutting is halted when penetration of the crimp ring is observed or halted by a stop.

### CROSS-REFERENCE TO RELATED APPLICATION

This application claims the benefit of U.S. Provisional Patent Application No. 61/790,119, filed Mar. 15, 2013, the disclosure of which is herein incorporated by reference.

### BACKGROUND OF THE INVENTION

1. Field of the Invention

The invention relates generally to the field of plumbing with flexible tubing. More specifically, the invention pertains to tools for removing cold formed, crimp rings commonly used with such plumbing.

2. Description of the Related Art

Flexible tubing has become prevalent in a wide range of plumbing applications-particularly where supply lines are required. Benefits include a significant savings in materials, installation, and time over traditional plumbing systems. In contrast to the threading or soldering required by traditional rigid systems, flexible plumbing is typically connected by simply sliding pieces of tubing over specialized plastic or metal fittings. Once the tubing is fitted, a ductile ring is crimped around the outside of the tubing to secure the connection. Insert fittings for the tubing are produced in a variety of configurations and are designed to form a tight connection with tubing of a particular size.

Besides being easy to install, flexible plastic plumbing systems have the potential to be easily modified and repaired. However, such work requires the disassembly of crimped ring connections. Typically the rings are cut and/or pried away from the outside of a given connection. Salvaging the rings is unnecessary due to their low cost. In contrast, the insert fittings are expensive and are generally worth re-using if possible.

Various methods and tools exist for removing crimp rings from flexible plumbing connections. A popular method involves sawing or grinding through the crimp ring while the connection is fully assembled. As would be expected, the method offers little precision, and too often results in damage to the tubing and internal fitting. This method also requires that the user have enough space to position and operate a saw or grinder, which is not commonly the case in many installations.

A similar method involves first cutting the tubing beyond the insert fitting, and then sawing or prying the ring from the remaining piece of tubing still present on the fitting. This method necessarily sacrifices some of the flexible tubing and may require additional struggle to extract the wasted length of tubing from the system.

Specialized crimp ring cutters are also available to ease the chore of removing rings. One example of such devices is plier-like in appearance and includes a pair of jaws. When operated, one of the jaws is inserted into the insert fitting hollow and the other is permitted to contact the crimp ring on the outside of the plumbing connection. Jaw travel is limited for the purpose of preserving the integrity of the insert fitting. As long as a short length of hose is able to be spared, such devices may be used for most flexible plumbing connections. However, this tool cannot accommodate the smallest common size tubing/fitting because of physical restraints.

The advantages of preserving flexible plumbing insert fittings and tubing lengths when removing crimp rings are exemplified in U.S. Pat. No. 6,769,181 to Scheuerman and U.S. Pat. No. 6,425,183 to Lemmens. The Scheuerman invention removes crimp rings by driving a fairly wide chisel blade in a path that is tangential to the inner diameter of the ring. By going no deeper than the thickness of the ring band, the invention avoids contact with the exterior tubing surface and preserves the underlying connection fitting. In contrast, the Lemmens tool directs relatively pointed cutting jaws toward the sides of a crimp ring band from opposing lateral directions, parallel to the direction of the tubing length. Since the cutting surfaces of the jaws are oriented away from the exterior tubing surface, damage to the underlying assembly is minimized.

While the plier-like devices are improvements over earlier methods, each is accompanied by its own disadvantages. All require significant force to shear the crimp ring band, which in some circumstances may be difficult to apply. Some require careful positioning to produce a cut which reliably preserves the underlying structures of the plumbing connection. Others are difficult to stabilize and may require repeated attempts before actually removing the ring. Still others can potentially damage the integrity of fittings when cutting force is transferred to internal components of the plumbing connection.

Therefore, there is a need for a crimp ring removal tool that is easily positioned to provide reliable and controlled penetration of crimp rings with minimal damage to plumbing connections, despite being operated in crowded or difficult confines.

### SUMMARY OF THE INVENTION

Accordingly, the present invention is directed to an improved device and methods for removing cold formed crimp rings from flexible tubing connections. In a first aspect of the present invention, a device is adapted for removing crimped metal rings in conjunction with common auxiliary cutting tools. Guided by the device, the auxiliary tools serve to cut crimp rings in a rotating or reciprocating motion, thereby avoiding the need to transfer great force to a plumbing connection.

The collar-like tool of the present invention includes a bore within a collar block that is fitted closely to the outside dimensions of a flexible plumbing connection. The bore of the collar block is approximately equal to the outer diameter of flexible tubing that has been secured over an insert fitting. In preferred embodiments, the bore of the collar block is semi-cylindrical and contacts the outer circumference surface of the tubing for approximately 180 degrees. However, other shapes are also functional so long as the tool makes stable contact with the plumbing connection. In preferred embodiments, the collar block also includes one or more clamping areas, more or less opposite the bore, adapted for securing the tool and plumbing connection inside the jaws of a variety of clamping mechanisms such as locking pliers. After being tightened, the pliers hold the tool steadily in position over the plumbing connection as the crimp ring is being removed. In alternate embodiments, a clamping means is made integral with the construction of the collar block.

The collar block further comprises a ring slot within or adjacent to the bore and a guide path having plumbing and cutting tool ends. The ring slot is sized to fit closely over the crimp ring and serves to index the collar block to the flexible tubing connection. The guide path of the collar may be adapted for various cutting tools such as drills, grinders, or saws, and communicates with the ring slot so as to present the operative portion of the cutting tool to the crimp ring at the guide path plumbing end. Depending on the nature of the auxiliary cutting tool the collar may be constructed to limit the depth of cutting tool penetration, thereby protecting the components of the plumbing connection from becoming damaged. In alternative embodiments, specialized bits, blades, or stones incorporating depth limiting features may be adapted for preserving underlying connection components.

In accordance with the present invention, the collar block may include multiple bores and ring slot pairs corresponding to the outside dimensions of various standard tubing connection sizes. Furthermore, a single bore and ring slot pair may communicate with multiple guide paths, permitting the use of different cutting tools and allowing the plumbing connection to be approached from different directions according to the confines of a particular space. In further preferred embodiments, the collar block also comprises one or more sight paths for viewing the crimp ring as it is penetrated by the auxiliary cutting tool.

In a second aspect, methods are disclosed for removing crimp rings according to the present invention. Once indexed in position, the collar block device is secured in place. In preferred embodiments, the collar block is clamped to the flexible plumbing connection with locking pliers. After the collar block is stabilized, the operative portion of an auxiliary cutting tool is directed toward the plumbing connection through the guide path. The auxiliary tool is activated and permitted to contact the crimp ring. Sawing, drilling, or grinding is continued as progress is monitored until the ring is completely penetrated or until a stop is met. Depending on the skill of the operator, the collar block may be removed periodically if necessary to monitor the cut. In preferred embodiments, the operative portion of the auxiliary cutting tool is a drill or mill bit and progress of the cut is observed through the guide path upon removing the auxiliary cutting tool but without unclamping the collar block. In further preferred embodiments, a separate sight path is included in the collar block to observe the ring as it is being cut.

It is an object of the present invention to provide a portable, lightweight, inexpensive tool for efficiently removing crimp rings from flexible plumbing connections with minimal damage and waste.

It is a further objective to provide a crimp ring removal tool that, through its ring slot and bore size, is compatible with standard sized flexible plumbing connections.

It is another object the present invention to provide a crimp ring removal device compatible with common cutting tools likely to be owned by professionals or homeowners.

It is still another object to provide a tool and method for removing crimped rings such that critical plumbing components are conserved.

It is a further object to provide a tool adapted for operation in spaces that are cramped or otherwise difficult to approach with conventional crimp ring removal tools.

### BRIEF DESCRIPTION OF THE DRAWINGS

FIG. 1 shows a partial cut away view of a typical flexible plumbing connection.

FIG. 2 shows a crimp ring removal tool having a closed bore and a guide path adapted for a reciprocating saw.

FIG. 3 is a view of a crimp ring removal tool having twin open bores and guide paths adapted for a drill type cutting tool.

FIG. 4 shows a crimp ring removal tool and associated components.

FIG. 5 shows a crimp ring removal tool having bore sizes for ⅜″, ½″, and ¾″ plumbing connections.

FIG. 6 shows a crimp ring removal tool with multiple guide paths adapted for use with different auxiliary cutting tools approaching the crimp ring at varied angles.

FIG. 7 depicts an embodiment of the invention that includes an integral clamping means and does not require an additional clamping device.

FIG. 8 is a view of a crimp ring removal tool having opposed plumbing contact surfaces.

FIG. 9 is a drawing of a crimp ring removal tool with improved clamping surfaces.

### DETAILED DESCRIPTION OF THE INVENTION

The present invention is directed to removing crimp rings from flexible plumbing systems having standardized external dimensions. Such systems are typically characterized by having plastic tubing conduit instead of rigid metal pipe. One popular flexible plumbing system incorporates cross linked polyethylene tubing joined with rigid insert fittings for use as water supply lines and is commonly referred to as PEX.

Shown in FIG. 1 is a standardized PEX connection 2. An insert fitting 4 is joined to standard circumference tubing 6. The insert fitting may be made of plastic but is typically metal and includes ribs 8 along its sleeve 9. PEX fittings are manufactured to strictly controlled dimensions and are available in a range of configurations to join, distribute, and orient the tubing as needed for a given application. A crimp ring 10 is applied over the outer circumference 12 of the tubing, approximately ⅛″ before its end. The crimp ring 10 secures the system components together and keeps the connection 2 intact.

In general, crimp rings 10 used with PEX plumbing are circular bands of malleable metal installed by compressing or cold forming the rings around fitted tubing ends. Since reliable plumbing connections require consistent deformation, crimp rings are manufactured to exacting tolerances. Similarly, the dimensions of tubing and insert fittings are carefully produced so as to permit measurement of the external diameter of the ring, after it has been crimped over its underlying components, to serve as a test of quality control.

As a result of the strict standardization of PEX water supply line system components, properly installed PEX connections can be expected to exhibit consistent external dimensions for any given component size. Tubing having outer circumferences of ⅜″, ½″, ¾″, and 1″ are most common. The corresponding external dimensions of completed connections for these sizes are given in Table 1 below.

TABLE 1
External Dimensions of Flexible Plumbing Components After Assembly

| Fitting | | |
|---|---|---|
| Size | Fitted Tubing O.D. | Fitted Crimp Ring O.D. |
| ⅜ | 0.500 Inches | 0.580 to 0.595 Inches |
| ½ | 0.625 Inches | 0.700 to 0.715 Inches |
| ¾ | 0.875 Inches | 0.945 to 0.960 Inches |

FIG. 2 shows a crimp ring removal tool according to the present invention comprising a collar block 14, a cylindrical bore 16 having a diameter and an adjacent larger diameter ring slot 18. Both the bore and ring slot are in communication with a guide path 20 designed for a reciprocating saw with a metal cutting blade. The bore of the tool is approximately 0.875 inches to correspond with the outside circumference of nominal ¾ inch PEX tubing and the ring slot is approximately 0.960 inches to accommodate a crimp ring after it has been cold formed over a fitted tubing end.

As shown in FIG. 2 the guide path is perpendicular to the bore center line 22 but in alternate embodiments the guide path may instead be positioned to direct the operative portion of an auxiliary cutting tool along a path that is tangential to the bore. In addition, the size and shape of the guide path may be designed to accommodate various cutting tool types including but not limited to mills, drills, saws, and grinders.

To remove a crimp ring using the device of FIG. 2 from a flexible plumbing connection as shown in FIG. 1, the tubing 6 is first severed just beyond the connection 2 taking care to avoid damaging the insert fitting sleeve 9. The tool is then indexed to the connection by threading the portion of tubing remaining on the fitting through the ring slot 18 and bore 16 of the collar block until the crimp ring 10 of the connection is substantially seated within the ring slot 18. The tool may be clamped or held in place by hand and cutting progress observed as the saw is directed through the guide path to penetrate the crimp ring. The blade of the saw is maintained substantially parallel with the internal sleeve 9 of the fitting and cutting progress monitored until the crimp ring 10 is thoroughly penetrated. After the ring is severed, the connection is disassembled by sliding or prying the ring away from the tubing 6 and/or removing the tubing from the insert fitting 4.

In all embodiments of the present invention the tool is collar-like, contacting or fitting closely around the outer circumference of a tubing end and over the outside diameter of a crimp ring in need of being removed. As shown in FIG. 2 the bore 16 and ring slot 18 are completely cylindrical, forming a closed plumbing contact surface having a 360 degree arc. However, in preferred embodiments of the present invention, the collar block comprises one or more bores which are only partially enclosed or “open”, so as to permit the tool to be indexed to an intact flexible plumbing connection without first severing the tubing. Such open bore embodiments include one or more bores in the collar block having a bore arc of approximately 180 degrees or less. An open bore tool in accordance with the present invention is used by clamping the tool against a flexible plumbing connection or holding the tool in place by hand. In either case, the open bore permits the tool to be easily indexed against intact plumbing while at the same time establishing stability for aligning the crimp ring to be removed with a guide path of the tool during cutting.

As shown in FIG. 3, a crimp ring removal tool according to the present invention comprises a collar block 14 and two open bores 16, each having an arc of roughly 180 degrees. The shape and dimensions of the bores 16 correspond with the partial circumference of two popular sizes of PEX tubing. Approximately centered along the length of each bore is an adjacent ring slot 18 adapted for the standard crimp ring that would be used to secure tubing to an appropriately selected rigid insert fitting. Each open bore and ring slot comprise a functional pair and the two open bore and ring slot pairs are oriented in the same direction. The collar block further comprises a plumbing side 26 and a cutting tool side 28. The bore and ring slot pairs together provide a plumbing contact surface 30 on the plumbing side 26 of the tool.

Still referring now to FIG. 3, guide paths 20 are provided in the collar block to intersect with the ring slots 18 in a radial direction perpendicular to the center lines 22 of the bores. The guide paths are adapted to accommodate the operative portion of a drill type cutting tool. Opposite the plumbing contact surfaces of each bore is a clamping area 32 for securing the tool against a flexible plumbing connection. The clamping areas are smooth but may also be ridged to provide greater friction. Various clamps, pliers, or similar functioning mechanisms may be used to contact the clamping area and hold the collar block securely against a flexible plumbing connection.

FIG. 4 shows the relationship between the tool of FIG. 3, a typical operative portion 34 of a portable drill type cutting tool, a flexible plumbing connection 2, and a set of locking pliers 36. To remove a crimp ring 10 from a tubing end 38, the tool is first indexed by aligning the appropriately sized ring slot of the collar block 14 with the ring to be removed and positioning the tool against the flexible tubing connection such that the tubing end 38 makes contact with the plumbing contact surface 30 of the collar block. Next, the pliers 36 are used to secure the crimp ring removal tool to the plumbing connection. A drill bit or mill bit with a diameter corresponding to the guide path leading to the crimp ring of the connection is selected and attached to a portable drill. The drill is activated and its operative portion is fed into the cutting tool end of the guide path until contact with the crimp ring 10 is made. Contact is maintained for a limited time not expected to result in complete penetration of the crimp ring and the auxiliary cutting tool is removed to observe the progress of the cut. Drilling and observing are repeated until the crimp ring is substantially severed. In an alternate preferred embodiment of the invention, a shoulder 35 on a drill bit is employed to limit the depth of cut so that it is prevented from substantially penetrating the tubing. In either case, after the ring is cut and the collar is unclamped from the connection, the crimp ring and flexible tubing 6 may be removed from the connection without damaging the fitting 4.

In a further preferred embodiment of the invention, a crimp ring removal tool comprises a collar block 14 having three bore and ring slot pairs 40, each oriented in the same direction and corresponding to the dimensions of three different standard size PEX flexible plumbing connections, as shown in FIG. 5. The bores and ring slots are open, all having an arc of approximately 180 degrees. The collar block is equipped with three separate clamping areas 32 approximately opposite each plumbing contact surface 30. The collar block of the tool further comprises three guide paths 20, adapted for drill type cutting bits. Each of the guide paths has a cutting tool end 42 where the operative portion of a drill is inserted into the collar block and an opposite plumbing end 44, intersecting the ring slot and communicating with the bore.

As described and shown in the previous figures it is critical that the bore of the crimp ring removal tool communicates with at least one guide path to accommodate the operative portion of an auxiliary cutting tool. In further preferred embodiments multiple guide paths exist within a collar block to communicate with a single bore.

As shown in FIG. 6 a crimp ring removal tool comprises a collar block 14 having an open bore and ring slot pair. The pair corresponds to the dimensions of a standard sized PEX plumbing connection and communicates with two separate guide paths. Each guide path 20 has a cutting tool end and a plumbing end. One of the guide paths is adapted for the operative portion of a drill type auxiliary cutting tool and the other is adapted for a reciprocating saw blade. The collar block 14 of the tool includes a plumbing side 26 and cutting tool side 28. Clamping areas 32 exist opposite the plumbing contact surface 30, one of the clamping areas being penetrated by the cutting tool end 42 of the drill type cutting tool guide path. The tool of FIG. 6 permits a drill type or a saw type cutting tool to be used for removing a crimp ring from a flexible plumbing connection and provides options for orienting the auxiliary cutting tools in different positions to avoid obstacles which would otherwise make approaching the crimp ring more difficult.

Referring now to the invention in general, a crimp ring removal tool according to the present invention may be manufactured in several ways, depending on the material to be used and the desired performance to be obtained. In a preferred embodiment, the collar block is machined from a solid block of steel having a thickness adequate to span a crimp ring and provide sufficient bore length to establish a plumbing contact surface which continues along the tubing end on at least one side of the ring slot. In alternate embodiments, a crimp ring removal tool is cast or formed. The collar block may also be manufactured by bending a length of metal plate to resemble a collar block having an open bore. In most cases, the collar block can be subsequently completed by machining away unwanted material or welding on additional material as is needed to perform the function of removing a crimp ring. In general, a metal crimp ring removal tool should be hardened to provide a long lasting guide path. Hardening may be directed at the entire tool or only at specific areas likely to be altered by contact with other components such as the operative portions of auxiliary cutting tools. For tools employing a drill type auxiliary cutting tool, a hardened steel or equivalent guide path insert may be fitted within softer material serving as the balance of the tool.

In other embodiments of the invention, softer, lighter, and less durable materials may be substituted for metal to comprise the collar block, particularly if a disposable tool is desired. In still other embodiments, the tool is manufactured as a ceramic or composite having rugged materials at critical support or contact points, such as the guide paths and ring slots of the tool.

As is shown in FIG. 7, a crimp ring removal tool comprises a collar block 14 manufactured by bending a metal plate to form a vertex and opposing arms. The collar block includes a plumbing side 26 and a cutting tool side 28 and presents an open bore 16 on the plumbing side as a result of its interior angle. Along each arm 46 are opposing openings 48 which together form a ring slot for capturing a crimp ring to be removed by the tool. A small cylinder 50 is welded to the collar block which communicates with the bore of the tool through the vertex of the collar block. Below the cylinder and between the arms, a sight path 51 permits visual monitoring of the crimp ring as it is cut. The tool further comprised and clamping mechanism integral with the collar block. One arm of the collar block includes a pivoted jaw 52. The other arm includes a tab 54 for cooperating with a threaded member 56 to tighten the jaw against a flexible plumbing connection.

A further preferred embodiment of a crimp ring removal tool in accordance with the present invention is shown in FIG. 8, having plumbing contact surfaces oriented in different directions, along parallel and opposing sides. The tool comprises a collar block 14 having a first side 56 and a second side 58. A large bore and ring slot pair 60 corresponding to the dimensions of a ¾″ flexible plumbing connection and a medium bore ring slot pair 62 corresponding to the dimensions of a ½″ flexible plumbing connection are located on the first side of the collar block and a small bore and ring slot pair 64 adapted to the dimensions of a ⅜″ flexible plumbing connection is located on the second side. Each of the bore and ring slot pairs communicates with one of three guide paths 20 adapted for the operative portion of a drill type cutting tool. Each guide path 20 transverses the collar block and penetrates the side of the collar block opposite the bore and ring slot pair with which it communicates through a cutting tool end opening 65. The guide paths are substantially parallel with one another and transverse the collar block in a perpendicular direction so that the openings 65 are substantially round.

The surface of the second side 58 of the collar block 14 is divided into two portions by the small bore and ring slot pair 64. A higher portion 66 of the second side surface, opposite the large bore and ring slot pair, is farther from the first side of the collar block than a lower portion 68 of the second side opposite the medium bore and ring slot pair 62.

The collar block 14 further comprises clamping areas (not numbered) in proximity to the each guide path cutting tool end opening 65. The arcs of all three bores of the tool are approximately 180 degrees. However, the small bore and ring slot pair 64 located on the second side 58 of the collar block is asymmetrical so as to extend straight for a short distance 68 perpendicular to the second side 58 and adjacent with the higher portion 66 of the collar block.

In other embodiments, the bore and ring slot pair located on the second side of an opposing plumbing contact surface crimp ring removal tool is symmetrical. For instance, the second side of the collar block is made continuously parallel with the first side, without a high portion. Alternatively, a symmetrical bore and ring slot pair is located on the lower portion of the second side at a short distance from the high portion.

The quantity and arrangements of bore and ring slot pairs may also be varied for other opposing plumbing contact surface crimp ring removal embodiments. For example, the small bore and ring slot pair of a tool adapted to be indexed on three sizes of flexible plumbing connections is located on the same side of the collar block as the large bore and ring slot pair or a crimp ring removal tool in accordance with the present invention comprises only two bore and ring slot pairs having plumbing contact surfaces located on opposing sides of a collar block. Similarly, bore and ring slot sizes incorporated into the tool may be any one of various combinations.

In still other embodiments of crimp ring removal tools having open bore and ring slot pairs oriented in difference directions, collar blocks are substantially triangular or otherwise shaped to include non-parallel opposing sides. Moreover, drill type cutting tool guide paths in crimp ring cutting tool embodiments of the present invention may transverse collar blocks at a variety of angles while still being positioned in radial orientations to their respective ring slots and/or embodiments may include guide paths that do not run parallel to one another to provide better access for the operative portions of drill type cutting tools.

To clamp the removal tool of FIG. 8 to a flexible plumbing connection employing either the large 60 or medium 62 bore and ring slot pair, locking pliers may be positioned over one of the ends of the removal tool in relative alignment with the plane of the collar block or, alternatively, pliers may be positioned at an angle to the tool. Preferably, the small bore and ring slot pair 64 is clamped with locking pliers positioned at an angle to the plane of the collar block 14 because of its central position. However, other clamping devices may also be used for any of the bore and ring slot pairs so long as the jaws of the clamping device provide adequate reach.

As described herein, persons skilled in the art will understand that an improved crimp ring removal tool and methods have been disclosed which provides significant advantages over the prior art. The examples of embodiments provided are intended only as exemplary illustrations and not for the purpose of limiting the scope of claims to the present invention. Various changes, modifications, and equivalents in addition to those shown or described will become apparent to those skilled in the art and are similarly intended to fall within the spirit and scope of the invention whether or not they presently exist in the following or are later made in amended claims.

What is claimed is:

1. A tool for removing crimp rings from flexible plumbing connections which incorporate a rigid insert fitting within a flexible tubing end, the crimp ring removal tool comprising:
a collar block, having a plumbing side and a cutting tool side, said collar block adapted for being easily indexed and securely held against the tubing and crimp ring of a flexible plumbing connection;
a bore within the collar block forming at least part of a plumbing contact surface and corresponding in size to the outer circumference of the tubing; said bore having a centerline running parallel to the length of the bore;
a ring slot adjacent to said bore and corresponding in size to the diameter of a crimp ring after it has been compressed over the tubing end; and
a guide path communicating between the cutting tool side of the collar block and the bore; said guide path adapted for guiding the operative portion of an auxiliary cutting tool; whereby indexing the tool over a completed flexible plumbing connection positions the crimp ring within the ring slot of the collar block and exposes the crimp ring to the guide path for penetration by the operative portion of the auxiliary cutting tool.

2. The tool of claim 1 wherein the bore and the ring slot are sized to index the tool against standard sized flexible plumbing connections.

3. The tool of claim 2 wherein the bore is open and continuous with the plumbing side of the collar block, said bore having an arc of 180 degrees or less.

4. The tool of claim 3 further comprising a clamping area on the collar block, substantially opposite the plumbing contact surface.

5. The tool of claim 3 wherein the collar block comprises more than one bore, each bore communicating through the ring slot with at least one guide path.

6. The tool of claim 5 wherein the multiple bores are of assorted sizes to be compatible with an array of different sized standard flexible plumbing connections.

7. The tool of claim 6 comprising bores adapted to accommodate flexible plumbing connections which incorporate ⅜, ½, and ¾ inch nominal sized tubing.

8. The tool of claim 1 comprising multiple guide paths adapted to provide multiple options for directing the operative portion of an auxiliary cutting tool toward contact with a crimp ring, said paths being oriented in different directions so as to allow the auxiliary tool to approach the crimp ring from multiple positions.

9. A tool for removing a crimp ring from a flexible plumbing connection comprising:
a collar block, having a plumbing side and a cutting tool side, said collar block adapted for being easily indexed and securely held against a flexible plumbing connection;
at least one open bore, continuous with the plumbing side of the collar block, said bore having at least two points separated in distance to form a plumbing contact surface corresponding the outside circumference of a standard sized flexible plumbing connection; and
one or more guide paths communicating between the cutting tool side of the collar block and the bore; said guide paths having cutting toll and plumbing ends and being adapted for guiding the operative portion of an auxiliary cutting tool; whereby indexing the removal tool over a completed flexible plumbing connection positions the crimp ring at the plumbing end of the guide path to be penetrated by the operative portion of the auxiliary cutting tool.

10. The tool of claim 9 further comprising a clamping mechanism to hold the tool securely against a flexible tubing connection as the crimp ring is being penetrated.

11. The tool of claim 10 wherein the clamping method is integral with the collar block.

12. The tool of claim 9 further comprising a clamping area on the collar block, substantially opposite the plumbing contact surface.

13. The tool of claim 9 wherein the ring slot is substantially centered along the length of the bore.

14. A tool for removing crimp rings from completed flexible plumbing connections comprising:
a collar block having a first side and a second side, each of the sides having at least one plumbing contact surface;
a first open bore and ring slot pair forming the plumbing contact surface of the first side;
a first guide path communicating between the first open bore and ring slot pair and an opening on the second side, said first guide path adapted to direct an operative portion of a cutting tool into the first open bore and ring slot pair from the second side;
a second open bore and ring slot pair forming the plumbing contact surface of the second side; and
a second guide path communicating between the second open bore and ring slot pair and an opening in the first side, said second guide path adapted to direct an operative portion of a cutting tool into the second open bore and ring slot pair from the first side;
said first open bore and ring slot pair and said second open bore and ring slot pair being oriented on the collar block in substantially opposite directions and adapted for indexing the tool against flexible plumbing connections such that crimp rings to be removed are held steady within the open bore and rings slot pairs while being acted upon by the operative portion of the cutting tool.

15. The tool of claim 14 wherein the guide paths are adapted to direct the operative portion of a drill type cutting tool and the openings of the guide paths are located on opposing sides of the collar block.

16. The tool of claim 14 wherein the open bore and ring slot pairs are of assorted sizes to be compatible with different sized standard flexible plumbing connections.

17. The tool of claim 15 having three different sized open bore and ring slot pairs adapted to be indexed against flexible plumbing connections that incorporate ⅜, ½, and ¾ inch nominal sized tubing.

18. The tool of claim 17 wherein the ⅜ inch open bore and ring slot pair is on the opposite side of the collar block from the ¾ and the ½ inch open bore and ring slot pairs.

19. The tool of claim 18 wherein the guide paths are substantially parallel and have openings for receiving the operative end of a drill type cutting tool that are located on opposing sides of the collar block.
